(19) United States
(12) Patent Application Publication
(10) Pub. No.: US 2024/0077042 A1
(43) Pub. Date: Mar. 7, 2024

(54) NON-ROAD MOBILE MACHINERY (NRMM)

(71) Applicant: CHONGQING ZONGSHEN GENERAL POWER MACHINE CO., LTD., Chongqing (CN)

(72) Inventors: Bin YUAN, Chongqing (CN); Shikai ZHU, Chongqing (CN); Xudong CHEN, Chongqing (CN); Yichao WANG, Chongqing (CN); Yi ZHANG, Chongqing (CN); Xing CHEN, Chongqing (CN)

(73) Assignee: CHONGQING ZONGSHEN GENERAL POWER MACHINE CO., LTD., Chongqing (CN)

(21) Appl. No.: 18/116,845

(22) Filed: Mar. 3, 2023

(30) Foreign Application Priority Data
Sep. 2, 2022 (CN) 202211069023.9
Sep. 2, 2022 (CN) 202222329960.5

(51) Int. Cl. F02D 41/00

(52) U.S. Cl. CPC F02D 41/0032; F02D 2200/0406

(57) ABSTRACT

A non-road mobile machinery (NRMM) is provided and includes a fuel storage device, a fuel supply device, a vapor adsorption device, and an engine body. The vapor adsorption device is provided with an air vent communicated to the atmosphere. A vapor discharge hole of the fuel storage device is communicated to an adsorption vent of the vapor adsorption device. The NRMM also includes a valve mechanism connected between a desorption vent of the vapor adsorption device and an intake channel of the engine body. The valve mechanism is conducted with the working of the engine body and blocked with the stop of the engine body. The NRMN improves the evaporation emission performance of the NRMM when compared to the prior art and solves the problem that the evaporation emissions of the NRMM in the prior art are prone to exceed the standard.

### CROSS REFERENCE TO THE RELATED APPLICATIONS

This application is based upon and claims priority to Chinese Patent Application No. 202222329960.5, filed on Sep. 2, 2022; and Chinese Patent Application No. 202211069023.9, filed on Sep. 2, 2022, the entire contents of which are incorporated herein by reference.

### TECHNICAL FIELD

The present invention relates to a combustion engine for supplying fuel vapor discharged from a fuel tank to a combustion mixture, specifically a non-road mobile machinery (NRMM).

### BACKGROUND

An NRMM refers to mechanical equipment operated on non-public roads. The name aims at distinguishing the NRMM from engines used in road vehicles and facilitating the formulation of corresponding emission standards. The components of the NRMM include an engine body that burns fuel to generate mechanical energy, a fuel storage device for storing fuel, an air filtration device for filtering the air used for combustion, and a fuel supply device for supplying fuel to an intake channel of the engine body.

The emission sources of the NRMM are mainly exhaust emissions and fuel evaporation emissions. In the prior art, the method to reduce the fuel evaporation emissions of the NRMM is mainly by means of physical adsorption. A vapor discharge port of the fuel storage device is communicated to a vapor adsorption device, and an adsorption material in the vapor adsorption device is configured to adsorb the fuel vapor discharged by the fuel storage device. The vapor adsorption device is generally a tank storing activated carbon. The activated carbon is configured to adsorb the fuel vapor, and the vapor adsorption device is communicated to the air filtration device to reduce fuel evaporation emissions.

For example, a generator set evaporation control system disclosed in the Chinese patent document CN211819730U includes a fuel tank, a working unit, an air filter, and a carbon canister storing activated carbon. The fuel tank is communicated to the vapor adsorption device, and the carbon canister is communicated to the air filter through a vent pipe. When in use, the fuel vapor evaporated from the fuel tank enters the carbon canister and is adsorbed. When a working unit is in operation, the air filter generates negative pressure so that the fuel vapor adsorbed in the carbon canister is desorbed through the vent pipe and enters the working unit for combustion, which reduces the fuel evaporation emissions. Additionally, the carbon canister can re-adsorb the fuel vapor after desorption, which prevents the failure of the carbon canister due to reaching an adsorption saturation state.

In practical use, the prior means of reducing fuel evaporation emissions can make the evaporation emission value (sum of hot soak losses and diurnal losses) of the NRMM meet the requirements of the prior emission standards by limiting the value of the hot soak losses and diurnal losses (determined according to the volume of the fuel tank, and the limiting value of the evaporation emissions gets higher when the volume of the fuel tank increases). For example, in terms of a generator with a displacement of 224 cubic centimeters (cc) and a fuel tank volume of 13 L, the evaporation emission value of the generator is approximately 1.3 g, which meets the current emission standards. However, when the evaporation emission standards are raised and limited according to the engine displacement (e.g., a generator with a displacement of 224 cc should have a limiting value of the hot soak losses and diurnal losses less than 0.6 g), it is difficult to meet the higher requirements of emission standards by the prior means of reducing fuel evaporation emissions, resulting in that the problem of excess emissions still exists in NRMM.

### SUMMARY

The purpose of the present invention is to provide a NRMM to solve the problem that the evaporation emissions of a NRMM in the prior art are prone to exceed the standard.

To achieve the above purpose, the basic solution of the present invention provides a NRMM, including a fuel storage device, a fuel supply device, a vapor adsorption device, and an engine body. The vapor adsorption device is provided with an air vent that communicates with the atmosphere. A vapor discharge hole of the fuel storage device communicates with an adsorption vent of the vapor adsorption device. The NRMM also includes a valve mechanism connected between a desorption vent of the vapor adsorption device and an intake channel of the engine body. The valve mechanism is conducted (e.g., actuated, opened) with the operation of the engine body and is blocked or closed when the engine body ceases operation.

The advantages of this basic solution are as follows: With such a setting, an evaporation pollutant emission test of the NRMM is carried out, and it is found that an evaporation emission value of the NRMM is reduced by more than 60% compared with the evaporation emission value in the prior art, thereby it solves the problem that the NRMM is prone to produce excessive evaporation emissions under the higher requirements of emission standards.

Further, the valve mechanism includes a valve control device that controls the conduction and blocking of the valve mechanism according to the working state of the engine body. With such a setting, the operation of the conduction and blocking of the valve mechanism can be adjusted in time according to the change in the working state of the engine body to avoid the fuel vapor discharged from the air vent or the fuel vapor discharged from the intake channel of the engine body into the atmosphere caused by an adsorption saturation of the vapor adsorption device, thereby further reducing the evaporation emissions of the NRMM.

Further, the valve control device is a pressure-type control device that operates the valve mechanism according to a pressure change of the intake channel of the engine body. With such a setting, the valve control device can adjust the conduction and blocking of the valve mechanism in time according to the pressure change of the intake channel of the engine body without setting an additional power source. The simple structure is conducive to improving the reliability and timeliness of the valve mechanism during adjustment, thus further reducing the evaporation emissions of the NRMM.

Further, the pressure-type control device includes a fixed part and a drive part for operating the conduction or blocking of the valve mechanism. A cavity with variable volume is enclosed by the fixed part and the drive part. The pressure-type control device also includes a gas pressure pipe that communicates the cavity with the intake channel of the engine body. The pressure-type control device also includes an elastic reset part for a reset of the drive part. With such a setting, when the engine body is in a stop state, the intake channel of the engine body is in a normal pressure state, the volume of the cavity is in a large state, and the drive part makes the valve mechanism in a blocking state under the action of the elastic reset part. When the engine body is in the working state, the intake channel of the engine body produces negative pressure, so that a negative pressure will be formed in the cavity under the action of the gas pressure pipe communicated to the intake channel, the pressure outside the cavity is greater than the pressure inside the cavity, the drive part is moved or deformed after overcoming the force of the elastic reset part under the action of the pressure difference, and the valve mechanism is conducted. The pressure change of the intake channel is transmitted to the pressure-type control device in time through the gas pressure pipe, which is beneficial to simplify the structure of the pressure-type control device and improve its reliability.

Further, the valve control device is an electronic control device. When the engine body is in its working state, the electronic control device drives the valve mechanism to be conducted. When the engine body is in the stop state, the electronic control device drives the valve mechanism to be blocked. With such a setting, the valve control device can control the conduction and blocking of the valve mechanism more accurately, thereby further reducing the evaporation emissions of the NRMM.

Further, the fuel supply device is located outside the fuel storage device, and an equilibrium hole of the fuel supply device is communicated to the vapor adsorption device. With such a setting, the fuel vapor discharged from the equilibrium hole of the fuel supply device is absorbed by the vapor adsorption device, thereby facilitating the reduction of evaporation emissions of the NRMM.

Further, the equilibrium hole of the fuel supply device is directly communicated to the fuel storage device through an equilibrium vent pipe. With such a setting, the fuel vapor discharged from the equilibrium hole is collected in the fuel storage device and then absorbed by the vapor adsorption device together with the fuel vapor in the fuel storage device. Thus, the vapor adsorption device does not need a design for separate adsorption of the fuel vapor discharged from the equilibrium hole, which is beneficial to simplify the structural design of the vapor adsorption device.

Further, the equilibrium hole of the fuel supply device is directly communicated to a channel between the fuel storage device and the vapor adsorption device through the equilibrium vent pipe. With such a setting, there is no need to set more connecting ports on the fuel storage device and the vapor adsorption device, it can be used directly without changing the structure of the prior fuel storage device and the vapor adsorption device, and it is conducive to reducing production costs.

Further, the equilibrium hole of the fuel supply device is directly communicated to a channel located between the vapor adsorption device and the valve mechanism through the equilibrium vent pipe. With such a setting, the fuel vapor discharged from the equilibrium hole is first stored in the channel between the vapor adsorption device and the valve mechanism, and the vapor adsorption device together with the valve mechanism is configured to limit the fuel vapor released to the environment, which is beneficial to reduce the evaporation emissions further.

Further, the fuel supply device is a carburetor, an electric fuel injection (EFI) valve body, or an EFI pump. The carburetor, EFI valve body, and the EFI pump are all technically mature equipment for supplying fuel to the intake channel of the engine body, which is conducive to reducing the difficulty of improvement and further improving the performance to reduce evaporation emissions.

Compared with the prior art, the present invention reduces the evaporation emissions of the NRMM, the structure improvement is simple and feasible, and the cost is low. Through the test verification, the indexes of the evaporation emissions of the NRMM with the present invention are lower than the required limiting value of the emission standard, and the phenomenon of excess emissions is avoided.

### BRIEF DESCRIPTION OF THE DRAWINGS

FIG. 1 is a schematic diagram of an NRMM according to Embodiment 1 of the present invention.

FIG. 2 is a schematic diagram showing the structure of the valve mechanism in Embodiment 1 of the present invention.

FIG. 3 is a schematic diagram showing the structure of the valve mechanism in Embodiment 1 of the present invention.

FIG. 4 is a schematic diagram showing the structure of Embodiment 2 of the present invention.

FIG. 5 is a schematic diagram showing the structure of Embodiment 3 of the present invention.

FIG. 6 is a schematic diagram showing the structure of Embodiment 4 of the present invention.

FIG. 7 is a schematic diagram showing the structure of Embodiment 5 of the present invention.

### DETAILED DESCRIPTION OF THE EMBODIMENTS

The terms as “communicated/communication” in the present invention shall be understood in a broad sense, and they may be understood as connecting directly for communication or connecting by means of intermediate transition parts, such as connecting by means of pipes for communication.

The detailed descriptions are as follows by means of specific embodiments:

The reference numerals in the attached drawings of the specification include: fuel storage device 1, adsorption vent pipe 2, vapor adsorption device 3, air vent 31, adsorption vent 32, desorption vent 33, desorption vent pipe 4, equilibrium vent pipe 5, engine body 6, fuel supply device 7, air filtration device 8, valve mechanism 9, housing 91, valve cavity 92, air-inlet channel 93, air-outlet channel 94, valve control device 10, fixed part 101, drive part 102, cavity 103, elastic reset part 104, gas pressure pipe 11.

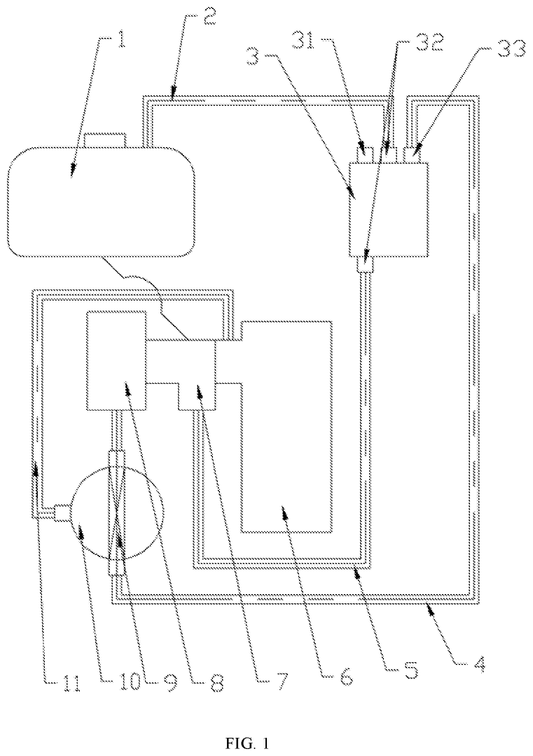

Embodiment 1: As shown in FIG. 1, a NRMM includes the fuel storage device 1, the vapor adsorption device 3, and the engine body 6. The fuel storage device 1 is equipped with a vapor discharge hole so that the fuel vapor in the fuel storage device 1 is discharged through the vapor discharge hole. In the embodiment, the vapor adsorption device 3 is a tank storing activated carbon, and the activated carbon is configured to adsorb fuel vapor. The vapor adsorption device 3 is provided with the air vent 31 communicated to the atmosphere so that when a positive pressure is formed inside the vapor adsorption device 3, the air is discharged through the air vent 31, and when a negative pressure is formed inside the vapor adsorption device 3, the external air enters the interior of the vapor adsorption device 3 through the air vent 31. The vapor adsorption device 3 is also provided with adsorption vents 32 for the fuel vapor to enter, and the desorption vent 33 for the fuel vapor to be discharged under negative pressure.

The vapor discharge hole of the fuel storage device 1 is communicated to one of the adsorption vents 32 of the vapor adsorption device 3. In the embodiment, the vapor discharge hole is communicated to one of the adsorption vents 32 of the vapor adsorption device 3 through the adsorption vent pipe 2. The valve mechanism 9 is connected between the desorption vent 33 of the vapor adsorption device 3 and an intake channel of the engine body 6. In the embodiment, the desorption vent pipe 4 is connected between the desorption vent 33 of the vapor adsorption device 3 and the intake channel of the engine body 6, and the valve mechanism 9 is installed on the desorption vent pipe 4. The conduction (e.g., actuation, opening) and blocking between the desorption vent 33 and the intake channel of the engine body are realized through the conduction and blocking of the valve mechanism 9.

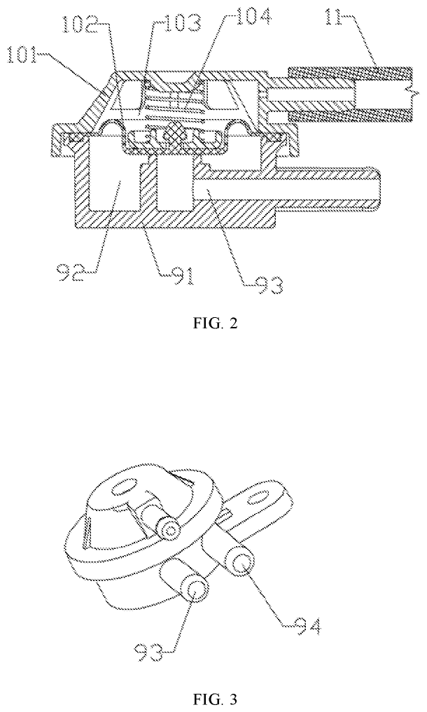

The valve mechanism 9 is conducted with the operation of the engine body 6 and blocked with the stop of the engine body 6. The valve mechanism 9 includes the valve control device 10 that controls the conduction and blocking of the valve mechanism 9 according to the working state of the engine body 6. It is convenient to switch the valve mechanism 9 between the conduction and blocking states through the valve control device 10. In this embodiment, the valve control device 10 is a pressure-type control device. As shown in FIGS. 2 and 3, the valve mechanism 9 includes the housing 91, and the inside of the housing 91 is provided with the valve cavity 92. The housing 91 is connected to the air-inlet channel 93 and the air-outlet channel 94 that are communicated to the valve cavity 92. The inside of the valve cavity 92 is provided with a valve plate that is matched with the end of the air-inlet channel 93 in a clutched manner. When the valve plate is connected to the end of the air-inlet channel 93, the air-inlet channel 93 is blocked, and the valve mechanism 9 is in a blocking state. When the valve plate is separated from the end of the air-inlet channel 93, the air-inlet channel 93 and the valve cavity 92 are in the conduction state, and the valve mechanism 9 is in the conduction state. The pressure-type control device includes the fixed part 101 and the drive part 102, and the cavity 103 with variable volume is enclosed by the fixed part 101 and the drive part 102. In this embodiment, the fixed part 101 is connected and fixed with the housing 91, the drive part 102 is connected to the valve plate, and the drive part 102 drives the valve plate to move, thereby realizing the conduction or blocking of the valve mechanism 9. In the embodiment, the drive part 102 is preferably a diaphragm that can be deformed, the edge of the drive part 102 is fixed and connected to the fixed part 101, and the middle part of the drive part 102 can move when deformation occurs. The valve plate of the valve mechanism 9 is connected to the middle part of the drive part 102. In the embodiment, the valve plate and the drive part 102 are integrally formed. The pressure-type control device also includes the gas pressure pipe 11 that communicates the cavity 103 with the intake channel of the engine body. When the engine body is in the working state, the intake channel of the engine body produces negative pressure, and the cavity 103 between the fixed part 101 and the drive part 102 also produces negative pressure, so that the two sides of the drive part 102 produce a pressure difference and makes the drive part 102 to be deformed to make the drive part 102 drive the valve plate away from the end of the air-inlet channel 93 and make the air-inlet channel 93 and the air-outlet channel 94 in the conduction state. The pressure-type control device also includes a reset part for resetting the drive part 102. In the embodiment, the elastic reset part 104 is preferably a spiral spring, and the spiral spring is located in the cavity 103 enclosed by the fix part 101 and the drive part 102. One end of the spiral spring is connected to the fix part 101, and the other end of the spiral spring abuts the drive part 102, so that the drive part 102 has a tendency to keep the valve mechanism 9 blocked under the action of the spiral spring. When the engine body is in the stop state, the intake channel of the engine body is in a normal pressure state. Under the action of the elastic force of the elastic reset part 104, the drive part 102 drives the valve plate and the end of the air-inlet channel 93 to maintain a connected state, so that the air-inlet channel 93 of the valve mechanism 9 is in the blocking state with the air-outlet channel 94.

The intake channel of the engine body 6 is connected to the fuel supply device 7 for supplying fuel to the intake channel. For example, the fuel supply device 7 is a carburetor that mixes fuel and air in the prior art, and the mixed gas enters the engine body 6 for combustion. In another embodiment, the fuel supply device 7 may also be an EFI valve body or an EFI pump in the prior art, which supplies fuel to the engine body by means of electric injection. The fuel supply device 7 is equipped with an equilibrium hole for balancing the pressure of the internal fuel storage chamber. The equilibrium hole is communicated to one of the adsorption vents 32 of the vapor adsorption device 3, and the fuel vapor discharged from the equilibrium hole enters the vapor adsorption device 3 and is absorbed. In the embodiment, the equilibrium hole is communicated to one of the adsorption vents 32 of the vapor adsorption device 3 through the equilibrium vent pipe 5, and the vapor adsorption device 3 can be separately provided with one of the adsorption vents 32 connected with the equilibrium vent pipe 5 or provided with one adsorption vent 32 shared by the equilibrium vent pipe 5 and the adsorption vent pipe 2.

The vapor adsorption device 3 is communicated to an intake side of the fuel supply device 7 through the desorption vent pipe 4, and the intake side of the fuel supply device 7 is generally provided with the air filtration device 8 for filtering the air in the intake channel that is ready to enter the engine body. The end of the desorption vent pipe 4 is connected to the intake channel between the air filtration device 8 and the fuel supply device 7. When a negative pressure is generated in the intake channel, the fuel vapor discharged by the vapor adsorption device 3 through the desorption vent pipe 4 enters the intake channel with air and then enters the engine body 6 for combustion.

The specific process of the embodiment is as follows: The valve mechanism 9 is in the blocking state when the engine body 6 stops working, the fuel vapor in the fuel storage device 1 enters the vapor adsorption device 3 through the adsorption vent pipe 2, so that the fuel in the fuel vapor is adsorbed and the fuel vapor discharged by the fuel supply device 7 through the equilibrium hole also enters the vapor adsorption device 3 and is adsorbed. When the engine body 6 is switched to the working state, the valve mechanism 9 is switched from the blocking state to the conduction state under the pressure change of the intake channel of the engine body 6. Under the negative pressure of the intake channel of the engine body 6, the desorption vent pipe 4 generates the negative pressure, so that under the action of the negative pressure of the desorption vent 33, the fuel in the fuel vapor adsorbed in the vapor adsorption device 3 will be desorbed and discharged and finally enter the intake channel of the engine body 6 for combustion.

The results of the evaporation pollutant emission test (hot soak for 1 h and emissions for 24 h) of the prior art and the NRMM of the present invention (specifically, the test is conducted on a generator with a displacement of 224 cc and a tank volume of 13 L) are compared. Under the premise of not changing the tank volume, the evaporation emission value in the prior art is 1.34 g, and the evaporation emission value of the present invention is between 0.32 g and 0.47 g, that is, the evaporation emission value of the present invention is reduced by more than 60% compared with the evaporation emission value in the prior art, thereby solving the problem that NRMM is prone to produce excessive evaporation emissions under the higher requirements of emission standards.

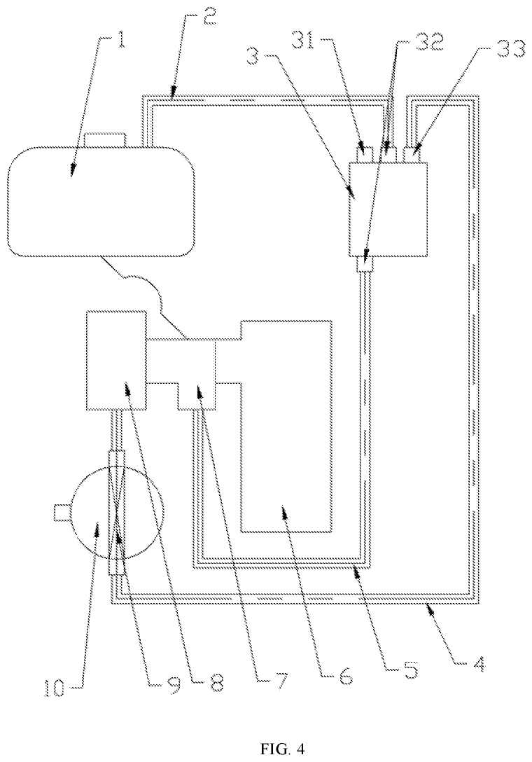

Embodiment 2: The differences from Embodiment 1 are as follows: As shown in FIG. 4, the valve control device 10 is an electronic control device. The electronic control device includes a working state signal acquisition module, a working state signal processing module, and an execution module for operating the valve mechanism 9 to switch between the conduction state and the blocking state of the engine body 6. When the engine body 6 is switched to the working state, a working operation signal is collected by the working state signal acquisition module and transmitted to the working state signal processing module, the working state signal processing module sends a conduction execution signal of the valve mechanism 9 to the execution module, and the execution module receives the conduction execution signal of the valve mechanism 9 and drives the valve mechanism 9 to be conducted. When the engine body 6 is switched to the stop state, a working stop signal is collected by the working state signal acquisition module and transmitted to the working state signal processing module, the working state signal processing module sends a blocking execution signal of the valve mechanism 9 to the execution module, the execution module receives the blocking execution signal of the valve mechanism 9 and drives the valve mechanism 9 to be blocked. With such a setting, the valve control device 10 can control the conduction and blocking of the valve mechanism 9 more accurately.

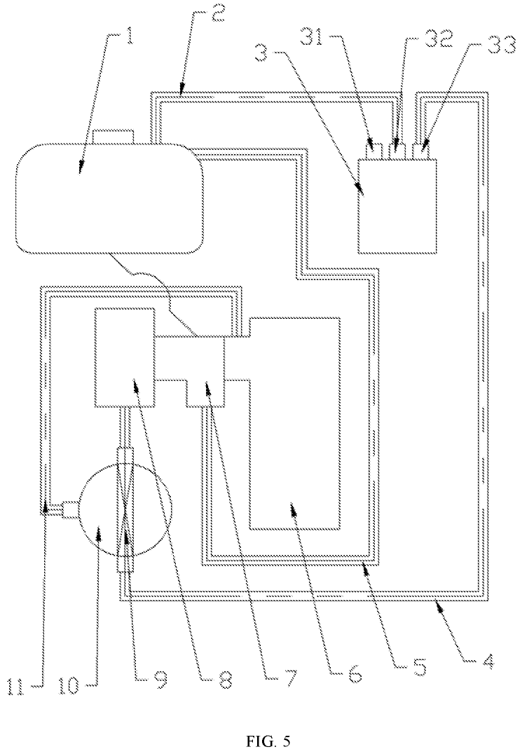

Embodiment 3: The differences from Embodiment 1 are as follows: As shown in FIG. 5, the equilibrium hole is communicated to the fuel storage device 1 through the equilibrium vent pipe 5. With such a setting, the fuel vapor discharged from the equilibrium hole is collected in the fuel storage device and then absorbed by the vapor adsorption device 3 together with the fuel vapor in the fuel storage device 1. The vapor adsorption device 3 does not need a design for the separate adsorption of the fuel vapor discharged from the equilibrium hole, which is beneficial to simplify the structural design of the vapor adsorption device 3.

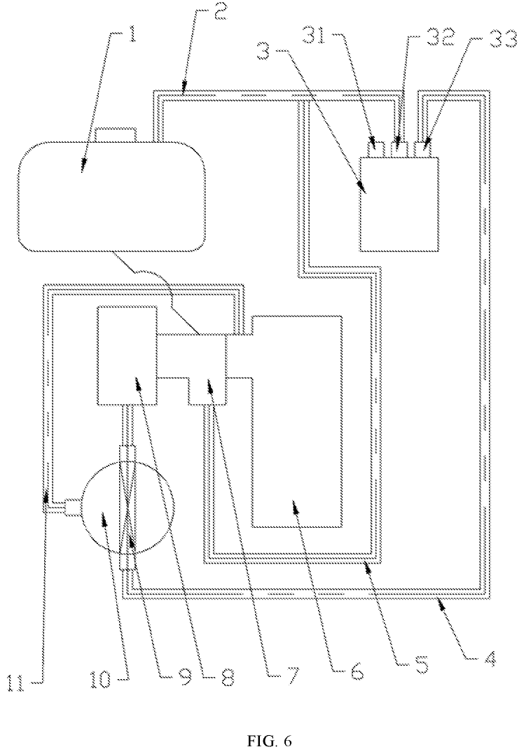

Embodiment 4: The differences from Embodiment 1 are as follows: As shown in FIG. 6, the equilibrium hole is communicated to the adsorption vent pipe 2 through the equilibrium vent pipe 5, and the equilibrium vent pipe 5 and the adsorption vent pipe 2 are connected by a three-way joint. With such a setting, there is no need to set more connecting ports on the fuel storage device 1 and the vapor adsorption device 3, so it can be used directly without changing the structures of the prior fuel storage device 1 and the vapor adsorption device 3, which is conducive to reducing production costs.

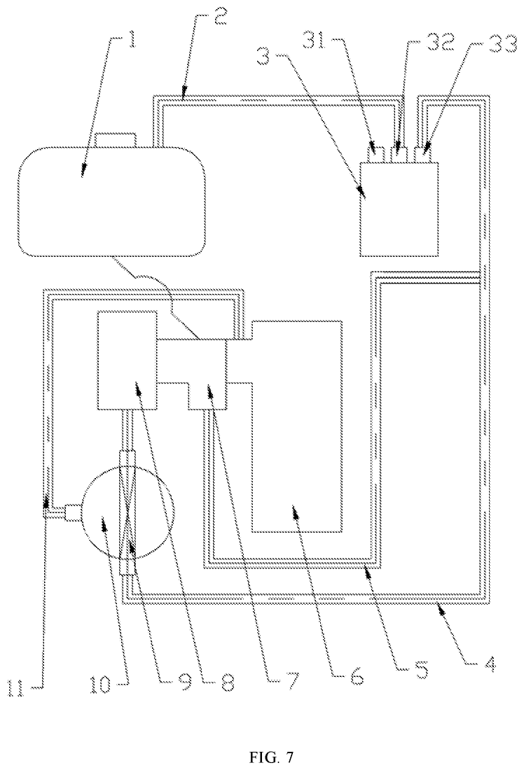

Embodiment 5: The differences from Embodiment 1 are as follows: As shown in FIG. 7, the equilibrium hole is directly communicated to a section of the desorption vent pipe 4 between the vapor adsorption device 3 and the valve mechanism 9 through the equilibrium vent pipe 5. With such a setting, the fuel vapor discharged from the equilibrium hole is first stored in the channel between the vapor adsorption device and the valve mechanism, and the vapor adsorption device together with the valve mechanism is configured to limit the fuel vapor into the environment, which is beneficial to further reduce the evaporation emissions.

The above descriptions are only embodiments of the present invention, and the common knowledge of the solutions, such as the specific structure, characteristics, and the like, is not described in detail here. It should be pointed out that for those skilled in the art, a number of modifications and improvements can be made without departing from the scope of the present invention, and those shall also fall within the scope of protection of the present invention, which will not affect the effect of the embodiments of the present invention and the practicality of the patent.

What is claimed is:

1. A non-road mobile machinery (NRMM), comprising a fuel storage device, a fuel supply device, a vapor adsorption device, and an engine body;
wherein the vapor adsorption device is provided with an air vent communicated to an external atmosphere outside the vapor adsorption device; a vapor discharge hole of the fuel storage device is communicated to an adsorption vent of the vapor adsorption device;
wherein the NRMM further comprises a valve mechanism connected between a desorption vent of the vapor adsorption device and an intake channel of the engine body; the valve mechanism is conducted with a working of the engine body and blocked with a stop of the engine body.

2. The NRMM according to claim 1, wherein the valve mechanism comprises a valve control device, wherein the valve control device controls a conduction and blocking of the valve mechanism according to a working state of the engine body.

3. The NRMM according to claim 2, wherein the valve control device is a pressure-type control device, wherein the pressure-type control device operates the valve mechanism according to a pressure change of the intake channel of the engine body.

4. The NRMM according to claim 3, wherein the pressure-type control device comprises a fixed part and a drive part for operating the conduction or blocking of the valve mechanism; a cavity with a variable volume is enclosed by the fixed part and the drive part; the pressure-type control device further comprises a gas pressure pipe, wherein the gas pressure pipe communicates the cavity with the intake channel of the engine body; the pressure-type control device further comprises an elastic reset part for a reset of the drive part.

5. The NRMM according to claim 2, wherein the valve control device is an electronic control device; when the engine body is in the working state, the electronic control device drives the valve mechanism to be conducted; when the engine body is in a stop state, the electronic control device drives the valve mechanism to be blocked.

6. An NRMM, comprising a fuel storage device, a fuel supply device, a vapor adsorption device, and an engine body;
wherein the vapor adsorption device is provided with an air vent communicated to an external atmosphere outside the vapor adsorption device; a vapor discharge hole of the fuel storage device is communicated to an adsorption vent of the vapor adsorption device; wherein an equilibrium hole of the fuel supply device is communicated to the vapor adsorption device.

7. The NRMM according to claim 6, wherein the equilibrium hole of the fuel supply device is directly communicated to the fuel storage device through an equilibrium vent pipe.

8. The NRMM according to claim 6, wherein the fuel supply device is located outside the fuel storage device.

9. The NRMM according to claim 6, wherein the fuel supply device is a carburetor, an electric fuel injection (EFI) valve body, or an EFI pump.

10. The NRMM according to claim 8, wherein the fuel supply device is a carburetor, an EFI valve body, or an EFI pump.

11. The NRMM according to claim 7, wherein the fuel supply device is located outside the fuel storage device.

12. The NRMM according to claim 7, wherein the fuel supply device is a carburetor, an electric fuel injection (EFI) valve body, or an EFI pump.
